(19) United States
(12) Patent Application Publication
(10) Pub. No.: US 2021/0362985 A1
(43) Pub. Date: Nov. 25, 2021

(54) MULTIPLE-LAYOUT GRAPPLE

(71) Applicant: Idrojet S.r.l., Catania (IT)

(72) Inventors: Danilo LA FERLA, Catania (IT); Fabio LA FERLA, Catania (IT)

(73) Assignee: Indojet S.r.l., Catania (IT)

(21) Appl. No.: 17/052,544

(22) PCT Filed: May 3, 2019
(86) PCT No.: PCT/IB2019/053628

§ 371 Date: Nov. 3, 2020

(30) Foreign Application Priority Data
May 9, 2018 (IT) 102018000005202

(51) Int. Cl. B66C 3/16; B66C 13/40

(52) U.S. Cl. CPC B66C 3/16; B66C 13/40

(57) ABSTRACT

A multiple-layout grapple (I, 100), for lifting and handling loads, including: a support frame (2); a suspension hook (3) of the grapple according to a suspension line (L); and at least three hinge seats (5) connected to said support frame (2), each seat (5) carrying a corresponding gripping arm (10), hinged so as to be adapted to rotate about a closing axis (0) orthogonal to the direction of the suspension line (L) between an open position and a closed position; wherein at least one of said hinge seats (5) is a hinge seat rotatably connected to said support frame (2) through a respective pin (7), so as to be adapted to rotate about a configuration axis (C) orthogonal to said closing axis (0) and to make said grapple to assume a predefined operating configuration.

The present invention relates to a multiple-layout grapple, for lifting and handling loads of various shape and nature, in particular heavy loads such as for example loads with compact shape or loads with elongated shape, pipes, extractors of tube bundles or the like.

### BACKGROUND

It is well known, and even easily to understand, that when one works with very cumbersome and heavy (several tons) loads, having particular shapes, such as for example loads having very elongated shape (even tens of meters), it is necessary to use grapples having specific shape for their lifting and/or handling.

For this reason, there are different types of grapples, each one having a specific gripping configuration, shape of the arms, and so on.

However, this involves the disadvantage of having to own and use different grapples, depending upon the types of loads to be lifted and/or handled.

### TECHNICAL PROBLEM SOLVED BY THE INVENTION

The object of the present invention is to solve the problems left unsolved by the known art, by providing a multiple-layout grapple for lifting and handling loads, as defined in claim 1.

Additional features of the present invention are defined in the corresponding depending claims.

The present invention involves several and evident advantages with respect to the known art.

The main advantage is that the same grapple can be modified in its gripping configuration, so as to be able each time to be adapted perfectly to the lifting and handling of loads having even very different shapes.

From this, the direct advantage follows that, even if one has one single grapple, it is possible to work in situations and under circumstances different therebetween, with loads each time of different type.

Moreover, an additional advantage is that the configuration can be modified in a very simple way, even when the grapple is assembled on the crane or other means which has to carry it, with the evident advantage of a greater effectiveness in terms of time and thus productivity.

Other advantages, together with the features and use modes of the present invention, will result evident from the following detailed description of preferred embodiments thereof, shown by way of example and not for limitative purpose.

### BRIEF DESCRIPTION OF THE FIGURES

The drawings shown in the enclosed figures will be referred hereinafter in this description, wherein:

FIG. 1 is an axonometric view of a grapple according to the present invention, in a first operating configuration, in closed position;

FIG. 2 is a top plan view of the grapple of FIG. 1;

FIGS. 3 and 4 are side views of the grapple of FIG. 1, taken along the directions A and B of FIG. 2, respectively;

FIG. 5 is a partially exploded view of the grapple of FIG. 1;

FIG. 6 is an axonometric view of a grapple according to the present invention, in a second possible operating configuration, in closed position;

FIG. 7 is a top plan view of the grapple of FIG. 6;

FIGS. 8 and 9 are side views of the grapple of FIG. 6, taken along the directions A and B of FIG. 7, respectively;

FIG. 10 is an axonometric view of the grapple of FIG. 6, in open position;

FIG. 11 is side view of the grapple of FIG. 10, in closed position;

FIG. 12 is an axonometric view exemplifying the use of a grapple according to the invention, in an operating configuration useful for lifting an extractor of tube bundles; and

FIGS. 13 and 14 show, in a top plan view, by way of example, an embodiment of a grapple according to the present invention, with three gripping arms.

### DETAILED DESCRIPTION OF PREFERRED EMBODIMENTS

The present invention will be described hereinafter by making reference to the above-mentioned figures.

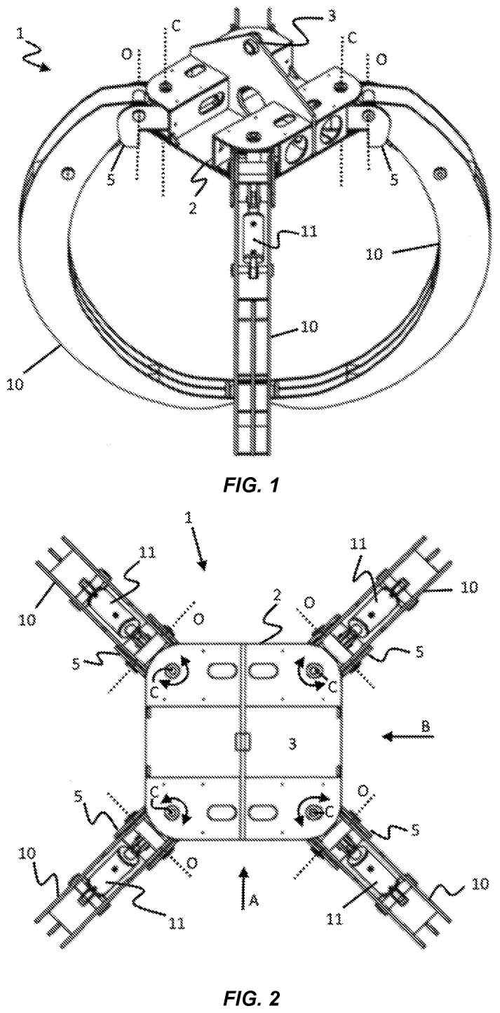

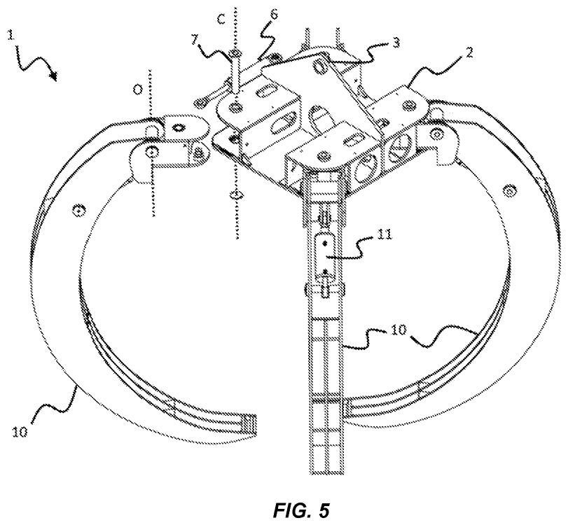

In particular, FIGS. 1 to 5 show a grapple 1 according to the present invention. In the specific case, the grapple 1 is shown in a first possible operating configuration.

The grapple 1 first of all comprises a support frame 2. A suspension hook 3 is connected to the support frame 2, which suspension hook can be used for hanging the grapple 1 according to an operating suspension line L. Advantageously, the hook 3 is arranged so that the suspension line passes through the centre of gravity of the grapple, so that the same is perfectly balanced when it is under suspension.

At least three hinge seats 5 are connected to the support frame 2, each hinge seat thereof bears a corresponding gripping arm 10, preferably shaped like an arch, hinged so as to be adapted to rotate about a closing axis O orthogonal to the direction of the suspension line L, between an open position and a closed position of the grapple.

According to the present invention, at least one of the hinge seats 5 is a hinge seat rotatably connected to the support frame 2 through a respective pin 7, so as to be adapted to rotate about a configuration axis C orthogonal to the closing axis O, so as to make the grapple 1 to assume a predefined operating configuration.

It is to be meant that the other hinge seats 5 which are not rotatably connected to the support frame 2, will be connected firmly to the latter, through fastening means, or alternatively obtained directly from the support frame 2.

Preferably, the hinge seats 5 are arranged peripherally on the support frame 2, substantially angularly evenly-spaced therebetween. This to guarantee that the grapple is always well balanced as a whole.

Moreover, according to some embodiments, at least two of said at least three hinge seats 5 are hinge seats rotatably connected to the support frame 2. This feature simplifies the fact of obtaining the wished operating configurations, by allowing a greater configuration flexibility.

Of course, it is to be meant that even an embodiment is possible wherein all hinge seats 5 are rotatably connected to the frame 2.

In particular, the embodiment shown in FIGS. 1 to 5 comprises four hinge seats 5 and four corresponding gripping arms 10.

In the specific case, such embodiment provides that all four hinge seats 5 are rotatably connected to the support frame 2.

In particular, according to the illustrated embodiment, the support frame 2 has a substantially quadrangular plan shape. Even in this sense, it is to be meant that such specification is purely indicative.

The four hinge seats 5, and then the respective gripping arms 10 are arranged at the four vertexes of such quadrangle, at 90° from one another.

It is clear that, for example, should the grapple provide only three arms, they could advantageously be arranged at 120° from one another, and so on.

Advantageously, the rotatably connected hinge seats 5 can rotate by an angle of at least 45° about said configuration axis C.

Of course, such angle could be also different, depending upon needs.

According to the present invention, the grapple 1 provides, for each gripping arm 10, a corresponding closing actuator 15 for moving the corresponding arm 10 in rotation about the respective closing axis O.

Analogously, the grapple 1 can provide, for each one of the hinge seats rotatably connected to the frame 2, a corresponding configuration actuator 6 for moving the corresponding hinge seat in rotation about the respective configuration axis C.

Preferably, all actuators, both the closing ones 11 and the configuration ones 6, can be of hydraulic cylinder type. However, it is of course to be meant that actuators of different nature (electric or other ones) could be used in a wholly equivalent way.

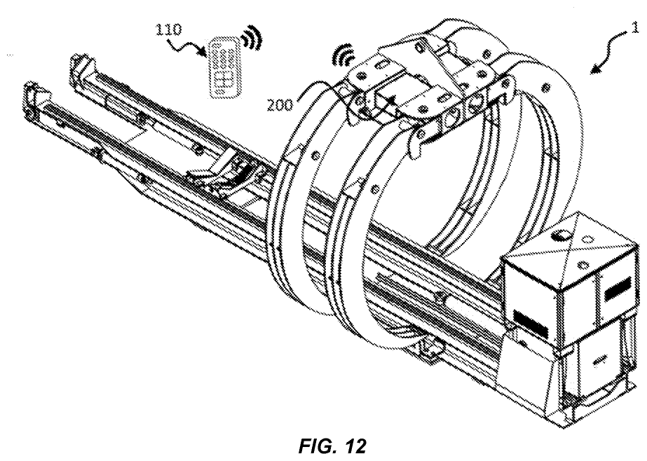

Advantageously, as shown by way of example in FIG. 12, it can be provided that the actuation can be remotely controlled, preferably by means of a wireless control system thus including a radio control 110. To this purpose, it is advantageous that the actuation system 200 including the thermal engines which are useful for the actuation (for example for the hydraulic circuit of the cylinders) and/or the energy source (for example batteries) for feeding electric motors, is wholly housed in the grapple, together with a wireless transceiver system. In this way, the remote handling of the grapple results particularly simple and more effective.

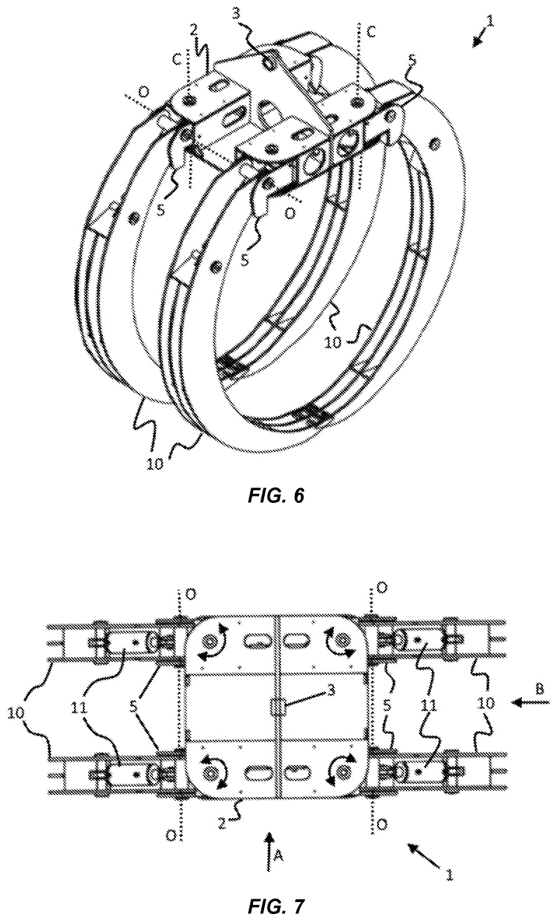

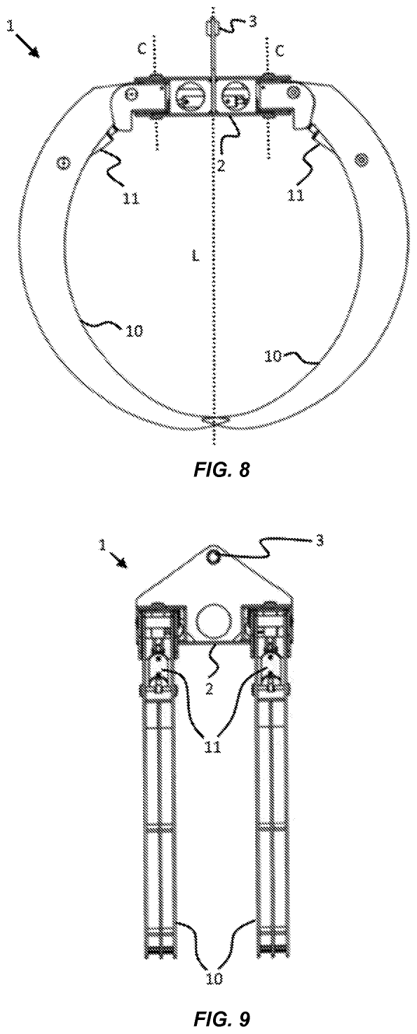

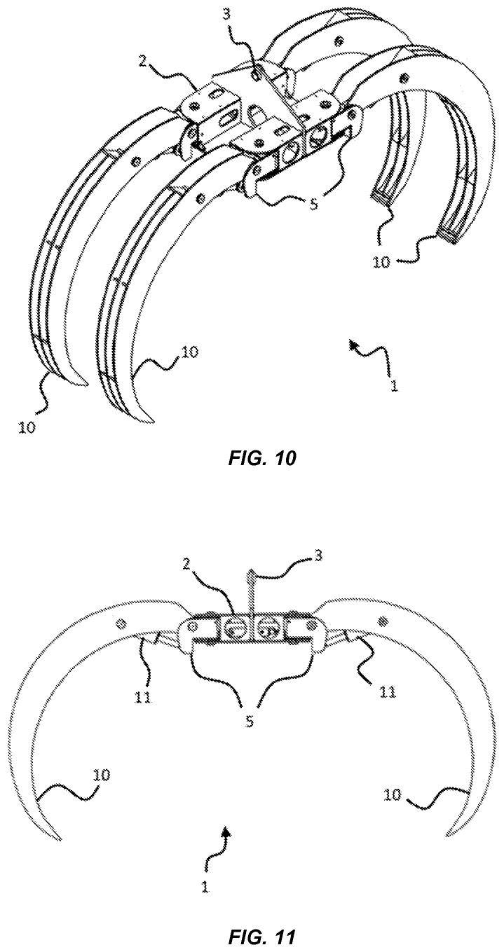

The subsequent FIGS. 6 to 11 show the grapple 1 in a second possible operating configuration.

In particular, the passage from an operating configuration to the other one, for example from the first configuration shown in FIGS. 1 to 5 to the second configuration shown in FIGS. 6 to 11, takes place through a rotation of one or more of the hinge seats rotatably connected to the frame, about the respective pin 7.

In the preferred example shown in figures, the grapple 1 has four arms 10 and all hinge seats 5 are rotatably connected to the frame 2, so as to be able to rotate about respective pins 7.

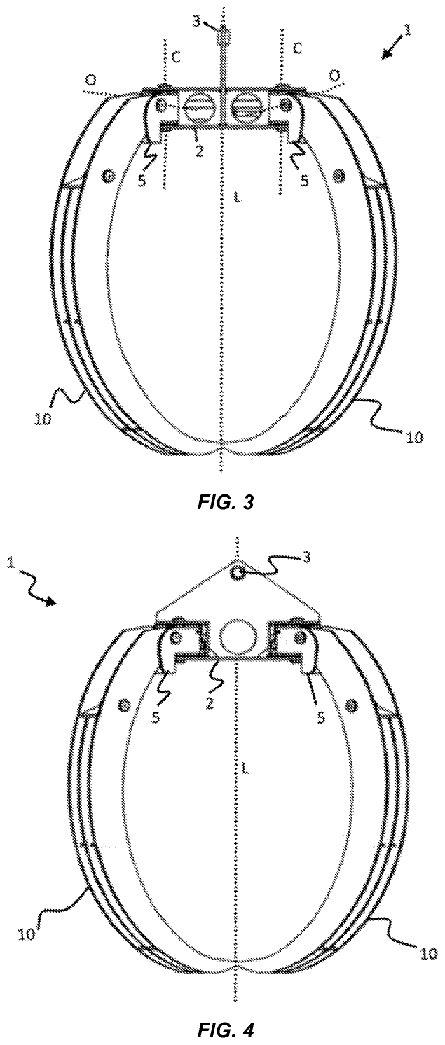

Therefore, in order to move on from the first configuration (plan view of FIG. 2) to the second configuration (plan view of FIG. 7), each arm 10, through a rotation of about 45° of the respective hinge seat 5 has been moved. Then, whereas in the first configuration (FIG. 2) the arms 10 are “cross”-like arranged, in the second configuration (FIG. 7) the arms are “H”-like arranged.

It is clear that the first configuration is more effective in hooking loads having compact, spherical shape or the like, whereas the second configuration is more suitable for hooking elongated, cylindrical loads or the like.

For example, FIG. 12 shows by way of example a grapple 1, in the herein described operating configuration (“H”-like shape), used for lifting and handling an extractor of tube bundles.

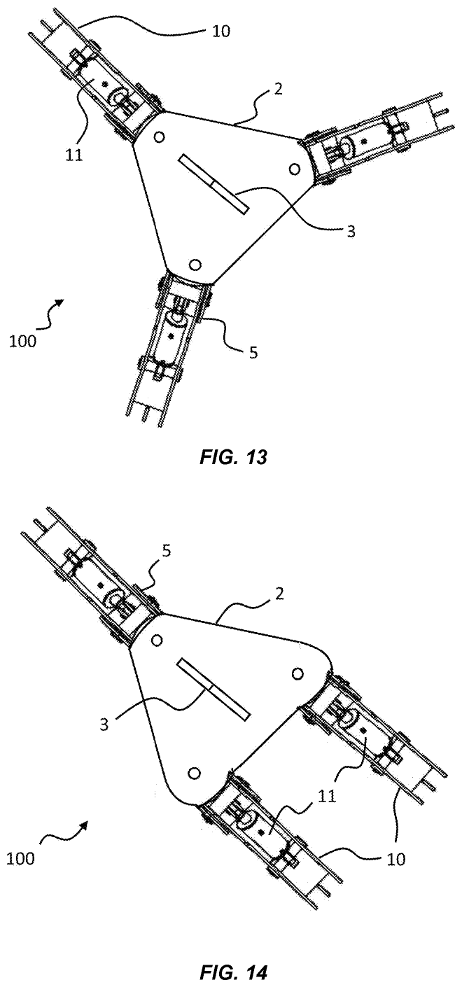

By pure way of example, FIGS. 13 and 14 are top plan views of a second possible embodiment of a grapple 100 according to the present invention. In these figures, portions already described with reference to the preceding embodiments and unchanged, keep the same numeration and will not be described herein again.

In particular, according this embodiment, the grapple provides three gripping arms 10, which by the way was already described in general terms.

In the specific case, the three hinge seats 5 are arranged at 120° with respect to one another, and at least 2 are rotatably connected to the support frame 2.

In the specific case FIG. 13 shows the grapple in a configuration wherein the gripping arms 10 too are oriented at 120° , to form a “spider”-like grapple, whereas FIG. 14, two of the hinge seats are rotated, so that the corresponding arms are parallel therebetween and also parallel with respect to the third opposite arm, so as to assume a different configuration, more useful for lifting long and/or cylindrical loads.

It is also to be meant that even for a grapple 100 according to the latter embodiment, although not shown in figures, an actuation system could be provided directly on board of the grapple and preferably remotely controllable.

The present invention has been sofar described with reference to preferred embodiments thereof. It is to be meant that each one of the technical solutions implemented in the preferred embodiments, herein described by way of example, can advantageously be combined, in a different way with respect to what described, with the other ones, to create additional embodiments, belonging to the same inventive core and however all within the protective scope of the herebelow reported claims.

1. A multiple-layout grapple, for lifting and handling loads, including:
a support frame;
a suspension hook of the grapple according to a suspension line; and
at least three hinge seats connected to said support frame, each seat carrying a corresponding gripping arm, hinged so as to be adapted to rotate about a closing axis orthogonal to the direction of the suspension line between an open position and a closed position;
wherein at least one of said hinge seats is a hinge seat rotatably connected to said support frame through a respective pin, so as to be adapted to rotate about a configuration axis orthogonal to said closing axis and to make said grapple to assume a predefined operating configuration.

2. The grapple according to claim 1, including, for each gripping arm a corresponding closing actuator for moving the arm in rotation about the respective closing axis.

3. The grapple according to claim 1, including at least one configuration actuator for moving said at least one hinge seat rotatably connected to said support frame in rotation about the respective configuration axis.

4. The grapple according to claim 2, wherein said closing actuators and said at least one configuration actuator are of hydraulic cylinder type.

5. The grapple according claim 1, wherein said at least three hinge seats are substantially angularly equally spaced therebetween with respect to said suspension line.

6. The grapple according to claim 1, wherein at least two of said at least three hinge seats are rotatably connected to said support frame.

7. The grapple according to claim 1, including four hinge seats and four corresponding gripping arms.

8. The grapple according to claim 1, wherein all hinge seats are rotatably connected to said support frame.

9. The grapple according to claim 1, wherein said gripping arms are shaped like an arc.

10. The grapple according to claim 1, wherein said rotatably connected hinge seats can rotate by an angle of at least 45° about said configuration axis.

11. The grapple according to claim 1, further comprising, on board, an actuation system for said closing actuators and/or said configuration actuators.

12. The grapple according to claim 11, further comprising a wireless control system for remotely controlling said actuation system, by means of a radio control.
